(19) United States
(12) Patent Application Publication
(10) Pub. No.: US 2002/0063836 A1
(43) Pub. Date: May 30, 2002

(54) Method of curing seal in liquid crystal display panel

(75) Inventors: Norio Oku, Motosu-gun (JP); Hideki Matsuoka, Gifu-shi (JP); Kazuyuki Maeda, Nishikasugai-gun (JP)

Correspondence Address: HOGAN & HARTSON L.L.P., 500 S. GRAND AVENUE, SUITE 1900, LOS ANGELES, CA, 90071-2611, US

(73) Assignee: SANYO ELECTRIC CO., LTD.

(21) Appl. No.: 09/917,099

(22) Filed: Jul. 26, 2001

(30) Foreign Application Priority Data
Jul. 28, 2000 (JP) 2000-229575

(51) Int. Cl. G02F 1/1339; G02F 1/1333

(52) U.S. Cl. 349/153

(57) ABSTRACT

A display panel body (110) is formed with a thermosetting seal material disposed in an outer peripheral region of a display area between a pair of substrates (10), and a thermally conductive buffer plate (300) is disposed on the side of the display panel body (110) opposite to the side where the substrates face each other. The buffer plate (300) is aligned such that an opening (302) therein overlaps each display area, and such that a lattice member (301) thereof overlaps the region where the seal material is disposed. The panel body (110) is pressed and heated from outside through the buffer plate (300), thereby heating and curing the thermosetting seal material. Because the display area overlaps the opening of the buffer plate, pressing of this area when the seal is cured can be prevented, thereby preventing the substrate from flexing at the display area of the display panel 110 provided with no spacers.

### BACKGROUND OF THE INVENTION

1. Field of the Invention

The present invention relates to curing a seal in a liquid crystal display panel.

2. Description of the Related Art

In common liquid crystal display devices (hereinafter referred to as LCDs), a seal material is disposed along the periphery of a display area of a pair of substrates to affix the two substrates and create a predetermined gap therebetween, into which liquid crystal is sealed. In large or medium sized LCDs used for devices such as computer monitors, televisions, and the like, spacers (dispersed material) formed of a resin dispersed in an appropriate region of the panel before the substrates are sealed are provided. In an LCD, maintaining a uniform gap in the cell (the gap between the substrates) is important because optical properties of the display device depend on the gap in the cell. When spacers are not provided in large or medium sized panels, the uniform cell gap in the panel cannot be maintained, the substrates are flexed, especially near the center of the cell, and the gap is narrowed. It is to prevent this from occurring that spacers are provided in the cells of such panels, to maintain a uniform gap throughout the display panel, and to thereby prevent adverse effects on display.

However, an image displayed on a liquid crystal display device used for a viewfinder (EVF) in a digital video camera recorder (DVR), a digital still camera (DSC), or the like, or for a projector or the like, may be enlarged to, for example, several, tens of, or even hundreds of times when presented to viewers. Consequently, spacers dispersed in the panel are also enlarged and are therefore visible to viewers, thereby degrading display quality. To avoid this, preferably, visible spacers are not dispersed in the cell of LCDs for displaying enlarged or projected images.

Usually such LCD panels for displaying enlarged or projected images are configured as small sized panels, and the cell gap can therefore be uniformly maintained throughout the panel surface of a completed device without any spacers in the cell.

However, in one common production method as shown in FIG. 1, when a thermosetting resin is used for a seal material, in the process of affixing the two substrates together (seal curing process), heating plates 200 sandwich the two substrates and apply pressure and heat thereto so that the seal material is cured. This heating plate 200 applies a pressure to the entire surface of the substrate. While in the peripheral region of the cell the seal material is provided to maintain the cell gap, because no means for maintaining the gap is provided near the center of the cell, the substrate may flex, creating a region with a smaller cell gap. Once the substrate is flexed, the cell gap cannot be recovered, leading to a decline in the display quality.

### SUMMARY OF THE INVENTION

In view of the problems described above, the present invention aims to provide a method for performing a seal curing process while maintaining a uniform cell gap, even in an LCD employing no spacers.

The present invention has been conceived to achieve the above object, and has the following characteristics.

The present invention provides a method of manufacturing a liquid crystal display panel in which a pair of substrates are affixed to each other at an outer peripheral region of a display area thereof with a predetermined gap therebetween and liquid crystal is sealed in a cell space formed between the opposing substrates in a region corresponding to said display area, and a thermosetting seal material is disposed in the outer peripheral region of the display area between said pair of substrates to form a display panel body. A thermally conductive buffer plate is then disposed at one or more outer surfaces of said pair of substrates of said display panel body, aligned so that an opening formed in said buffer plate overlaps the display area of said display panel body. Said thermosetting seal material is heated and cured while a pressure is applied from said outer surface of said display panel body to between said substrates through said buffer plate.

According to one aspect of the present invention, in the above manufacturing method, at the region of said display panel body where said seal material is disposed, said seal material is heated and cured while a pressure is applied thereto through a pair of heating plates disposed sandwiching at least said buffer plate disposed at said one or more outer surfaces of said pair of substrates.

In this manner, an opening is provided at a position of the buffer plate corresponding to the display area, and the display panel body is pressed and heated through the buffer plate while the opening of the buffer plate is aligned to overlap the display area, so that the seal material disposed in the periphery of the display area can be pressed and cured without applying a pressure to the substrate at the display area. Consequently, flexing of the substrate at the display area can be prevented, even when the seal of a liquid crystal display panel or the like includes no spacers in the display area. Narrowing of the space between the substrates (cell gap) in this area during processing is prevented.

According to another aspect of the present invention, in the above manufacturing method, a dummy substrate is disposed between at least a lower plate of said pair of heating plates and said buffer plate disposed under said display panel body, and at least a lower buffer plate, said display panel body, and an upper buffer plate are stacked on said dummy substrate in this order from the bottom in an aligned manner, and are introduced together with said dummy substrate to a space between said pair of heating plates.

By transporting the assembly of the above-described configuration in which the buffer plate with the opening and the display panel body are mounted on the dummy substrate, the buffer plate will not disturb processes, such as a transportation process, a process for introducing the assembly to the seal curing device, a process for curing the seal, and the like, even when the opening is formed in the buffer plate as in the present invention.

According to a still another aspect of the present invention, in the above manufacturing method, said display panel body includes a plurality of panel regions to be formed into liquid crystal display panels, and said thermosetting seal material is disposed in each of the panel regions in an outer peripheral region of an area to be formed into a display area of, and said buffer plate includes an opening formed at a position corresponding to said area of each of said panel regions.

Because a plurality of openings are provided in the buffer plate corresponding to the plurality of areas to be formed into display areas, the region where the seal material is disposed can be pressed and heated without applying a pressure to the designated display area. As a result, the display area is not pressed when the display panel or the like including no spacers therein is sealed, thereby preventing narrowing of the space between the substrates (cell gap) due to flexing of the substrates.

According to a further aspect of the present invention, the invention provides a buffer plate for applying a pressure to a display panel body in which a thermosetting seal material is disposed in an outer peripheral region of a display area between a pair of substrates, and conducting heat to said thermosetting seal material to cure the seal material, wherein an opening is formed at a position overlapping an area to be formed into the display area of said display panel body.

According to a further aspect of the present invention, in the above buffer plate, said display panel body includes a plurality of panel regions to be formed into display panels, and said thermosetting seal material is disposed in the outer peripheral region of an area to be formed into a display area in each of the panel regions, and an opening is formed at a position overlapping each said area to be formed into a display area of each of said panel regions.

By using the above-described buffer plate, and without substantially changing the seal curing device or the like, the seal material can be cured by pressing and heating only the periphery of the above area where the seal material is disposed without pressing the designated display area of the display panel.

As described above, the present invention enables prevention of substrate flexing in the display area because the region where the seal material is disposed is pressed and heated through the buffer plate having an opening at a position corresponding to the display area, while ensuring curing of the seal material disposed in the periphery of the display area.

### BRIEF DESCRIPTION OF THE DRAWINGS

FIG. 1 illustrates a defect associated with a conventional seal curing method.

FIG. 2 illustrates a seal curing method and operation of a seal curing device of a single substrate processing type according to an embodiment of the present invention.

FIG. 3 is a view for describing a configuration of a workpiece during a seal curing process and an assembling method according to the embodiment of the present invention.

FIG. 4 illustrates a configuration example of a buffer plate used in seal curing according to the present invention.

FIG. 5 is a view for describing in greater detail the configuration of the workpiece during the seal curing process according to the embodiment of the present invention.

FIG. 6 illustrates operation and configuration of a seal curing device of a batch processing type according to the embodiment of the present invention.

FIG. 7 illustrates an example of a cross sectional structure of the buffer plate used in seal curing according to the present invention.

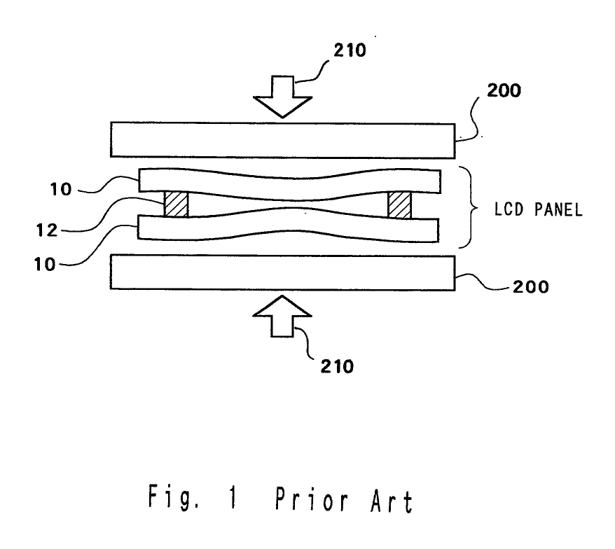

### DESCRIPTION OF THE PREFERRED EMBODIMENT

A preferred embodiment of the present invention will next be described with reference to the accompanying drawings.

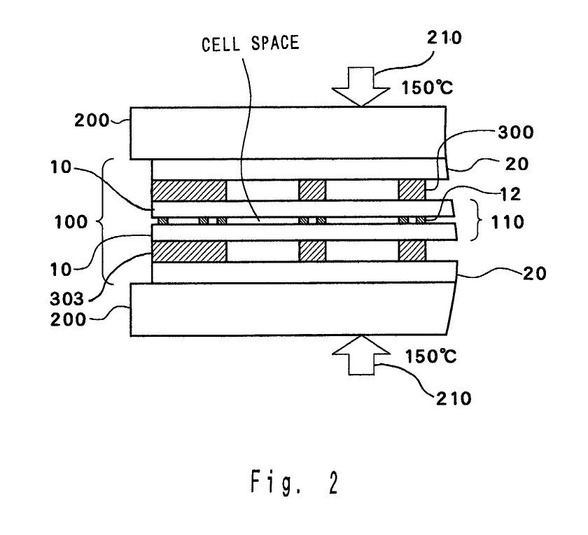

FIG. 2 shows an example of sealing (seal curing) of an LCD panel and a configuration of a sealing device according to the preferred embodiment of the present invention. The sealing device includes upper and lower heating plates 200, and a pressing mechanism 210. A display panel body 110 disposed between the heating plates 200 is heated while the pressing mechanism 210 applies a pressure thereto from above and below the body 110, thereby curing a thermosetting seal material 12 disposed along the periphery of a display area of a pair of substrates in the panel body 110. The pressing mechanism 210 may be provided either above or below the panel body 110 as long as a pressure can be applied to the panel body 110 from above and below (from the outer sides of the substrates, the sides opposite to the facing sides).

As shown in FIG. 2, a dummy glass 20 used for facilitating transportation of the panel, protecting the LCD panel, and other purposes, and a thermally conductive buffer plate 300, which is a characteristic feature of the present invention and has an opening at a position corresponding to a display area of the LCD panel, are provided between the heating plates 200 and the pair of substrates 10 of the LCD cell.

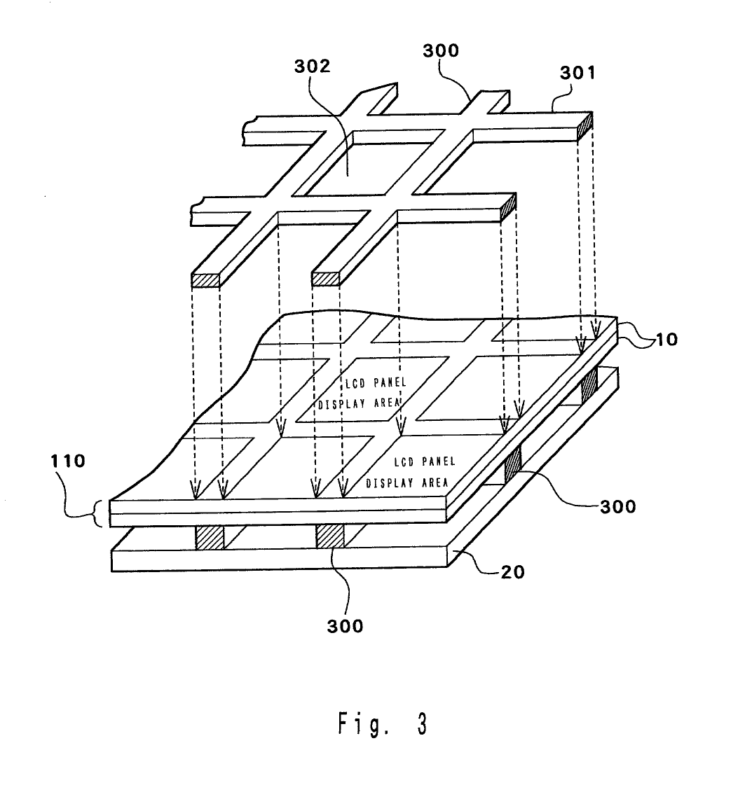

Because the LCD panel for displaying an enlarged or projected image as described above has a small display area on the order of 1 to 2 inches wide, for example, individually manufacturing such LCD panels is inefficient. Therefore, a so-called gang printing method is employed in which a plurality (on the order of, for example, hundreds) of LCD panel regions are formed on a large mother substrate and then separated. Such a gang printing method is also employed in the example of this embodiment, and a large mother substrate 10 is an insulating substrate 10 formed of glass or the like, as illustrated in FIG. 3. The seal material 12 is disposed between the pair of mother substrates 10 surrounding the area of each panel to be formed into a display area. The space formed by the seal material 12 and the upper and lower substrates is the cell space to which liquid crystal is to be introduced from an injection hole and sealed in order to form the display area of each LCD panel.

An example of a method of manufacturing an LCD device according to this embodiment will next be described. First, electrodes, elements, and the like (not shown) required for driving liquid crystal are formed at the pair of substrates 10 on the sides where the substrates face each other. On one of the substrates 10, the seal material 12 of a thermosetting resin is disposed along the periphery of each panel display area of the substrate by a printing method or the like. The other substrate 10 is aligned and mounted on the substrate 10 having the seal material 12 arranged thereon, thereby forming the display panel body 110.

A glass substrate having a size and a thickness similar to the substrate for the panel body is used as the dummy substrate 20, on which the lattice-shaped buffer plate 300 having an opening at a region corresponding to the display area of the LCD panel is mounted, as shown in FIG. 3. The above-described LCD panel body 110 is mounted thereon in an aligned manner so that the seal region is overlapped by lattice members 301 of the buffer plate 300, and each display area is overlapped by an opening 302 of the buffer plate. The alignment of the elements may be automated, or may be performed manually by human operators.

After the LCD panel body 100 is disposed on the lower buffer plate 300 having the above-described pattern, the lattice-shaped buffer plate 300 having the same pattern as the lower buffer plate 300 is mounted on the LCD panel body 110 aligned so that the opening overlaps the display area of the panel body 110. Similarly to the alignment between the lower buffer plate 300 and the panel body 110, the panel body 110 and the upper buffer plate 300 may be aligned automatically or manually by operators.

The configuration illustrated in FIG. 2 is used when the process for curing the seal material in the LCD panel is performed in single substrate units, i.e. when the process is performed for each panel body. According to such a single substrate processing, a single panel body is processed in a single process for curing the seal material. Thus, the upper dummy glass 20 is mounted on the upper buffer plate 300 as shown in FIG. 2, and an assembly in which a single panel body 110 is held by the upper and lower dummy glasses 20 and the upper and lower buffer plates 300 is treated as a single workpiece 100.

The workpiece 100 set as described above is then introduced into the sealing device illustrated in FIG. 2, and mounted on the lower heating plate 200. Thereafter, the upper heating plate 200 is brought into contact with the upper dummy glass 20, and the pressing mechanism 210 is operated to apply a pressure to the workpiece 100 from above and below the workpiece by means of the upper and lower heating plates 200. The heating plate 200 is heated to a temperature of, for example, 150° C. to heat the seal material between the substrates to approximately the same temperature, i.e. 150° C. in this example, through the upper and lower dummy glasses 20, and the upper and lower buffer plates 300, thereby curing the seal material 12. After the above seal curing process is performed, the panel body 110 is diced to respective LCD panels, or cut off for every row and column, and liquid crystal is introduced to each cell space and sealed therein in a vacuum atmosphere, thereby producing individual LCD panels.

The buffer plate according to the present invention will next be described in detail. The buffer plate 300 is characterized in that it has an opening at a position overlapping an area to be formed into the display area as described above, and has such a pattern that has a minimum overlapping area, i.e. a pattern that overlaps only each seal region of the display panel. For example, when a single display area is to be formed in the panel body, a single opening is formed in the buffer plate 300 so that the buffer plate is present not in the display area but in a position where the seal material is disposed surrounding the display area.

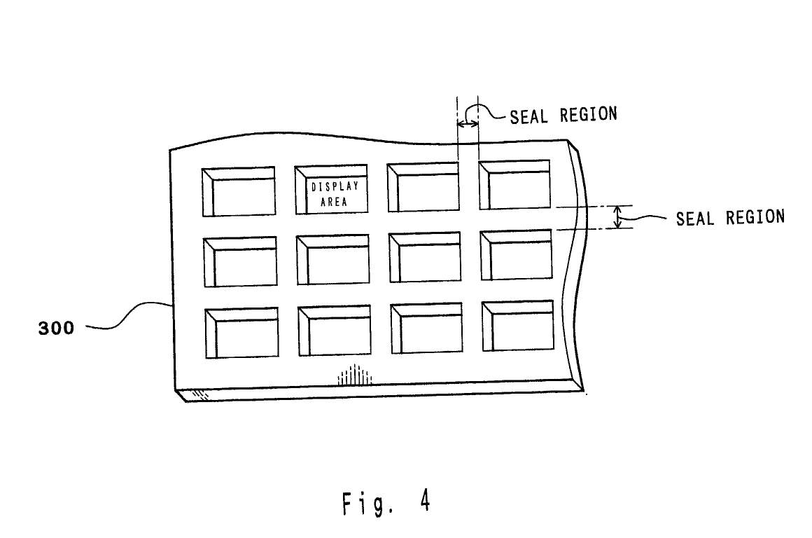

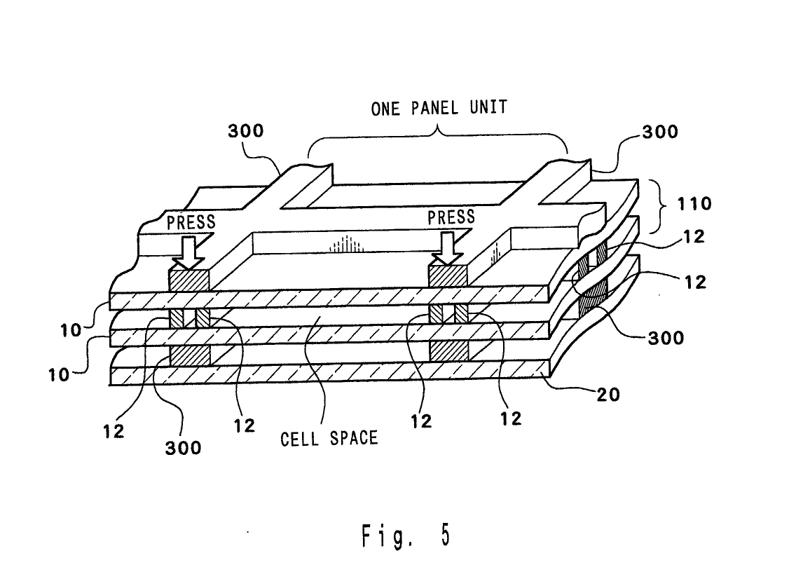

As described above, because the gang printing method in which a plurality of panels are formed from a single panel body is employed in this embodiment, the buffer plate 300 has an area substantially equal to the mother substrate (having a thickness of, for example, 0.7 mm or smaller), and has a thickness of, for example, about 1 mm. Referring to FIG. 3 and FIG. 4, the plate 300 has an opening 302 at a region corresponding to the display area of each of a plurality of panels formed in a single display panel body 110. The area of the buffer plate 300 is designed to be substantially equal to the mother substrate in order to facilitate alignment between the substrate and the buffer plate 300. The portion of the buffer plate 300 between openings, i.e. the lattice of the plate (lattice members 301), is formed as a pattern covering the seal regions along the periphery of respective display areas. More specifically, as shown in FIG. 5, the lattice member 301 of the buffer plate 300 is designed to have a width (of, for example, 5 mm) sufficient to simultaneously cover two seal regions for two adjoining LCD panels on the substrate. Naturally, the buffer plate 300 in the form of lattice having a width equivalent to that of a region where the seal material is actually disposed may be used instead of the plate having the pattern in which each lattice member covers the seals for the two adjoining panel regions as illustrated in FIG. 5, as long as the buffer plate can be finely machined and the panel can be accurately aligned with the buffer plate. While the buffer plate 300 illustrated in, for example, FIG. 3 has an orderly arranged lattice pattern to correspond to arrangement of a plurality of display panels to be formed at the panel body 110, the plate need not be in such a pattern as long as it has an opening corresponding to the display area of the display panel. Further, as the peripheral region of the mother substrate usually has a relatively large width (of, for example, 10 mm), the buffer plate can be easily handled during alignment with the panel body 110 when the peripheral region of the corresponding buffer plate 300 also has a relatively large width (of, for example, 10 mm). However, the peripheral region need not have such a large width.

The buffer plate 300 of the present embodiment must have a thermal conductivity sufficiently high to transmit heat from the heating plate 200 in the seal curing device to the seal material 12 of the panel, and an elasticity appropriate for allowing a pressure to be uniformly applied to the contacting surface without damaging the mother substrate formed of glass or the like. Further, the plate preferably has an appropriate degree of rigidity to facilitate handling during alignment. For the buffer plate 300, a 100% PTFE (polytetrafluoroethylene) sheet (such as that commercially available from Daikin Industries, Ltd. under the trade name “polyflon paper 10L”), for example, can be employed. However, the plate material is not limited to PTFE, and any material having appropriate thermal conductivity and rigidity can be employed. By providing the sheet formed of such a material with an opening corresponding to the display area, the sheet can be used as the buffer plate 300 having the pattern in accordance with the present invention. When, for example, the above PTFE sheet is used for the buffer plate 300 of this embodiment, the sheet shrinks due to heat, especially when heated for the first time. Therefore, before actually using the sheet as the buffer plate during the sheet curing process it is preferable to treat it with a preheating process similar to the curing process, so that the amount of shrinkage per heating is reduced. Because the shrinkage amount can be predicted, the step of providing in the sheet an opening corresponding to the display area can be performed either after the preheating process or before the preheating process by taking the shrinkage amount into consideration.

As described above, the seal curing process is performed using the buffer plate having an opening corresponding to the display area according to the present embodiment. Because the opening of the buffer plate 300 can be superposed on each display area of the display panel body 110, the display area will not be pressed while the seal region is pressed, and the cell gap in the cell space of the display area can therefore be uniformly maintained therein without providing any spacers in the cell.

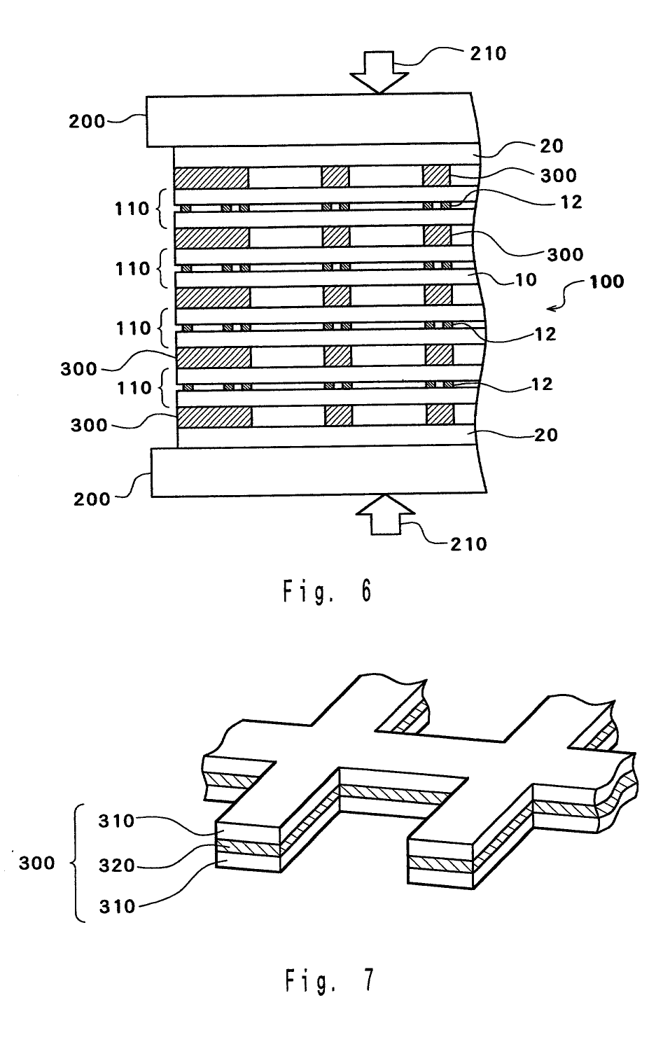

FIG. 6 illustrates the inside of the seal curing device when the seal is cured by a batch process, i.e. when a plurality of panel bodies 110 are simultaneously processed during a single seal curing process. While the upper and lower heating plates 200 and the pressing mechanism 210 are identical to those described in connection with FIG. 2, the workpiece 100 to be processed includes a plurality of stacked panel bodies 110. Similarly to the workpiece illustrated in FIG. 2, the workpiece 100 includes the upper and lower dummy glasses 20 at the uppermost and lowermost stages thereof. The buffer plate 300 similar to the one illustrated in FIG. 2 is disposed on the lower dummy glass 20, and the panel body 110 is disposed on the plate 300 aligned therewith. On this panel body, the plurality of panel bodies 110 are mounted, and the buffer plate 300 is disposed at each gap between the adjoining panel bodies 110 and aligned so that the opening overlaps each display area of each panel body 110 and that the lattice member overlaps the seal region. On the uppermost panel body 110, the upper buffer plate 300 and the upper dummy glass 20 are mounted, similarly to the configuration illustrated in FIG. 2. This workpiece 100 is also heated (at a temperature of, for example, 150° C.) by sandwiching it between the upper and lower heating plates 200 and applying pressure therethrough, so that the seal region of the panel body 110 at each stage can be heated while being pressed by the buffer plate 300, thereby curing the seal material 12. Pressing of the display area for each panel of each panel body 110 is also avoided in such a seal curing process of the batch type because the opening 302 (see FIG. 3) of the buffer plate 300 is superposed on the display area. In this way, the gap in the cell can be uniformly maintained at the panel surface without providing any spacers in the cell space when the seal is cured.

Preferably, to account for possible misalignment with the seal region, the width of each lattice member 301 of the buffer plate 300 described above is selected so as to ensure that the member 301 overlaps the seal region of the panel body even with when there is some deviation. A possible solution for enhancing accuracy of alignment between the seal region of the panel and the buffer plate 300 is to increase rigidity of the buffer plate 300. FIG. 7 illustrates across sectional structure of the buffer plate 300 with increased rigidity. This buffer plate 300 is composed of relatively soft buffer films 310 of PTFE or the like sandwiching a rigid film 320 formed of a material having high rigidity and thermal conductivity, such as a metal. When the plate 300 is provided with, in addition to the high thermal conductivity, both high rigidity as the plate 300 and elasticity at the surface thereof, handling of the plate 300 and its alignment with the panel body 110 can be facilitated for both human operators and automated alignment devices. In this manner, deformation of the plate during mounting on the substrate can be reduced, whereby more accurate alignment with the seal region of each panel can be achieved. Especially in the batch type configuration as illustrated in FIG. 6, accuracy of alignment with the seal region of the panel body is more crucial than in the configuration for the single substrate processing as illustrated in FIG. 2, and therefore using the buffer plate 300 having a sufficient rigidity to cope with the deformation as illustrated in FIG. 7 is especially advantageous.

The lattice member 301 of the buffer plate 300 is more easily flexed as the panel size increases. As a result, it is more likely that the seal region will not accurately overlap the lattice member 301 when the mother substrate and the peripheral portion 303 of the buffer plate are aligned. Therefore, the present invention is most effective in applications for a small-sized LCD of, for example, 2 inch or less, and more preferably 1 inch or less.

What is claimed is:

1. A method of manufacturing a liquid crystal display panel in which a pair of substrates are affixed to each other at an outer peripheral region of a display area thereof with a predetermined gap therebetween and liquid crystal is sealed in a cell space formed between the opposing substrates in a region corresponding to said display area, comprising the steps of:
disposing a thermosetting seal material in the outer peripheral region of the display area between said pair of substrates to form a display panel body;
disposing a thermally conductive buffer plate at one or more outer surfaces of said pair of substrates of said display panel body, aligned such that an opening formed in said buffer plate overlaps the display area of said display panel body; and
heating and curing said thermosetting seal material while applying a pressure from said outer surface of said display panel body to between said substrates through said buffer plate.

2. The method of manufacturing a liquid crystal display panel according to claim 1, wherein
said display panel body includes a plurality of panel regions to be formed into liquid crystal display panels, said thermosetting seal material is disposed in an outer peripheral region of an area to be formed into a display area of each of the panel regions, and
said buffer plate includes an opening formed at a position corresponding to said area of each of said panel regions.

3. The method of manufacturing a liquid crystal display panel according to claim 1, wherein
at the region of said display panel body where said seal material is disposed, said seal material is heated and cured while a pressure is applied thereto by a pair of heating plates disposed sandwiching said buffer plate disposed at each outer surface of said pair of substrates.

4. The method of manufacturing a liquid crystal display panel according to claim 3, wherein
a dummy substrate is disposed between at least a lower plate of said pair of heating plates and said buffer plate disposed under said display panel body, and
at least a lower buffer plate, said display panel body, and an upper buffer plate are stacked on said dummy substrate in this order from the bottom in an aligned manner, and are introduced together with said dummy substrate to a space between said pair of heating plates.

5. The method of manufacturing a liquid crystal display panel according to claim 3, wherein
said display panel body includes a plurality of panel regions to be formed into liquid crystal display panels, and said thermosetting seal material is disposed in each of the panel regions in an outer peripheral region of an area to be formed into a display area, and
said buffer plate includes an opening formed at a position corresponding to said area of each of said panel regions.

6. The method of manufacturing a liquid crystal display panel according to claim 3, wherein
no spacers for defining the gap between the substrates in said display area are provided in said display panel body.

7. The method of manufacturing a liquid crystal display panel according to claim 1, wherein
no spacers for defining the gap between the substrates in said display area are provided in said display panel body, and
at the region of said display panel body where said seal material is disposed, said seal material is heated and cured while a pressure is applied thereto by a pair of heating plates disposed sandwiching at least said buffer plate disposed at said one or more outer surfaces of said pair of substrates.

8. A buffer plate for applying a pressure to a display panel body in which a thermosetting seal material is disposed in an outer peripheral region of a display area between a pair of substrates, and conducting heat to said thermosetting seal material to cure the seal material, wherein
an opening is formed at a position overlapping an area to be formed into the display area of said display panel body.

9. The buffer plate according to claim 8, wherein
said display panel body includes a plurality of panel regions to be formed into display panels, and said thermosetting seal material is disposed in each of the panel regions in the outer peripheral region of an area to be formed into a display area, and
an opening is formed at a position overlapping said area to be formed into a display area of each of said panel regions.

10. The buffer plate according to claim 8, wherein
no spacers for defining a gap between the substrates in said display area are provided in said display panel body.
